(19) United States
(12) Patent Application Publication
(10) Pub. No.: US 2024/0314835 A1
(43) Pub. Date: Sep. 19, 2024

(54) ENHANCED CHANNEL ACCESS

(71) Applicant: InterDigital Patent Holdings, Inc., Wilmington, DE (US)

(72) Inventors: J. Patrick Tooher, Montreal (CA); Dylan Watts, Montreal (CA); Faris Alfarhan, Montreal (CA); Paul Marinier, Brossard (CA); Aata EI Hamss, Laval (CA)

(73) Assignee: InterDigital Patent Holdings, Inc., Wilmington, DE (US)

(21) Appl. No.: 18/271,558

(22) PCT Filed: Jan. 12, 2022
(86) PCT No.: PCT/US2022/012072

§ 371 Date: Jul. 10, 2023

Related U.S. Application Data
(60) Provisional application No. 63/136,248, filed on Jan. 12, 2021.

(51) Int. Cl. H04W 74/0808

(52) U.S. Cl. CPC H04W 74/0808

(57) ABSTRACT

Systems, methods, and instrumentalities are described herein for enhanced channel access. Resources may be configured to enable load-based equipment (LBE) access in an otherwise frame-based equipment (FBE) network. LBE access may be, for example, LBT category four (Cat 4). A wireless transmit/receive unit (WTRU) may determine whether an LBE resource is valid based on current channel occupancy. A WTRU may use an LBE resource as a function of a transmission priority (e.g., priority of the content of the transmission, for example a first PUSCH transmission may be associated with a first priority and a second PUSCH transmission may be associated with a second priority), transmission type (e.g., whether the transmission is for PUSCH or PUCCH, for DG-PUSCH or CG-PUSCH, for data or CSI or HARQ-ACK, etc.), requirement(s), and/or grant. A WTRU may use an LBE resource, for example, as a fallback resource.

### CROSS-REFERENCE TO RELATED APPLICATIONS

This application claims the benefit of Provisional U.S. Patent Application No. 63/136,248, filed Jan. 12, 2021, the disclosure of which is incorporated herein by reference in its entirety.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein for enhanced channel access. Resources may be configured to enable load-based equipment (LBE) access in an otherwise frame-based equipment (FBE) network. LBE access may be, for example, LBT category four (Cat 4). A wireless transmit/receive unit (WTRU) may determine whether an LBE resource is valid based on current channel occupancy. A WTRU may use an LBE resource as a function of a transmission priority (e.g., priority of the content of the transmission, for example a first PUSCH transmission may be associated with a first priority and a second PUSCH transmission may be associated with a second priority), transmission type (e.g., whether the transmission is for PUSCH or PUCCH, for DG-PUSCH or CG-PUSCH, for data or CSI or HARQ-ACK, etc.), requirement(s), and/or grant. A WTRU may use an LBE resource, for example, as a fallback resource. A WTRU may report measurements and/or may request to use LBE resources. A WTRU may be configured (e.g., with one or more restrictions) on when to use LBE resources and/or the type of listen-before-talk (LBT) to use for LBE resources. A WTRU may use LBE resources for random access (RA) and/or to avoid reconfiguration ambiguity.

A WTRU may receive configuration information. The configuration information may include an indication of a first resource associated with a first operating condition. The first resource may be in a first period. The WTRU may determine that data is available. The determination may occur during the first period. The WTRU may transmit the data. The data may be transmitted in the first period using a second resource, for example, if one or more conditions are satisfied. The second resource may be associated with a second operating condition. The conditions (e.g., set of conditions) may include one or more of the following: a first channel occupancy time (COT) associated with the first operating condition is not ongoing, an amount of time after the first COT associated with the first operating condition has ended exceeds a first threshold, an amount of time between the second resource and a second period exceeds a second threshold, or the WTRU has initiated a second COT.

The first operating condition may be a condition during which available data is allowed to be sent in a resource associated with the first operating condition in a period during which the available data becomes available if there is an ongoing first COT associated with the first operating condition or an amount of time after the first COT associated with the first operating condition has ended is below a threshold. The first operating condition may be associated with a frame-based equipment (FBE) configuration. The second operating condition may be a condition during which available data is allowed to be sent in a resource associated with the second operating condition in a period during which the available data becomes available if the one or more conditions are met. The second operating condition may be associated with a load-based equipment (LBE) configuration. The conditions (e.g., set of conditions as described herein) may include an activation being received and/or a priority of the data being above a third threshold. A value of the second threshold may be based on a priority of the data. In examples, as the priority of the data increases, the value of the second threshold may be decreased (e.g., and vice versa).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of gNB and WTRU FFP configurations.

FIG. 3 illustrates an example of a late arriving MAC PDU.

FIG. 4 illustrates an example of multiple transmissions colliding.

### DETAILED DESCRIPTION

Systems, methods, and instrumentalities are described herein for enhanced channel access. Resources may be configured to enable load based equipment (LBE) access in an otherwise frame based equipment (FBE) network. LBE access may be, for example, LBT category four (Cat 4). A wireless transmit/receive unit (WTRU) may determine whether an LBE resource is valid, for example, based on current channel occupancy. A WTRU may use an LBE resource, for example, as a function of a transmission priority, type, requirements, and/or grant. A WTRU may use an LBE resource, for example, as a fallback resource. A WTRU may report measurements and/or may request to use LBE resources. A WTRU may be configured (e.g., with one or more restrictions) on when to use LBE resources and the type of listen-before-talk (LBT) to use for LBE resources. A WTRU may use LBE resources for random access (RA) and/or to avoid reconfiguration ambiguity.

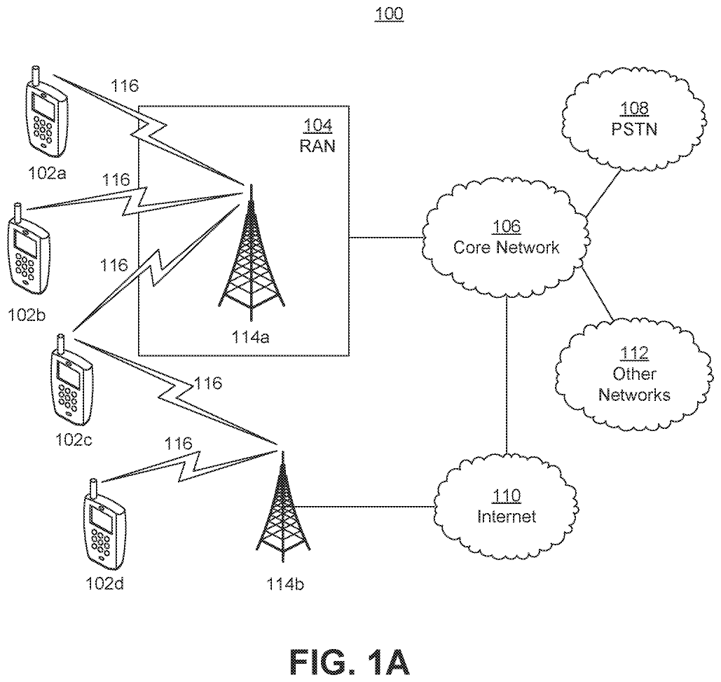

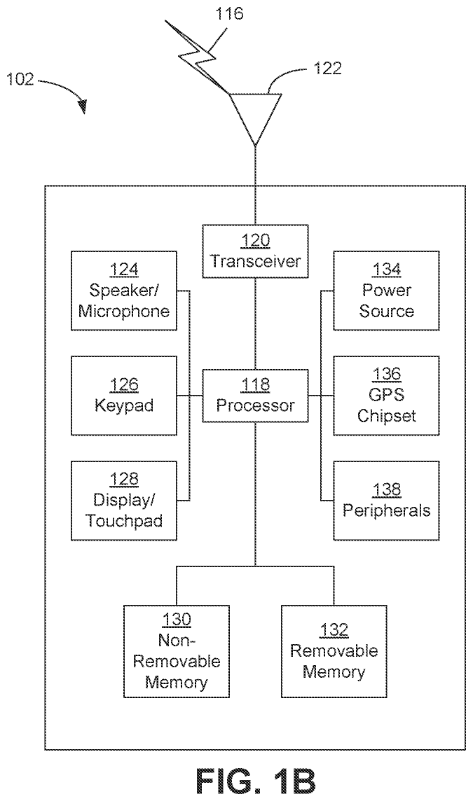

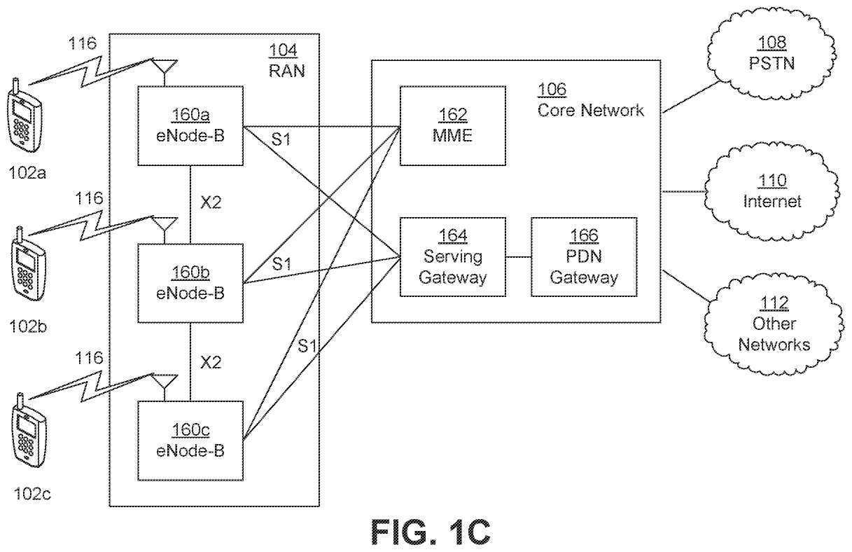

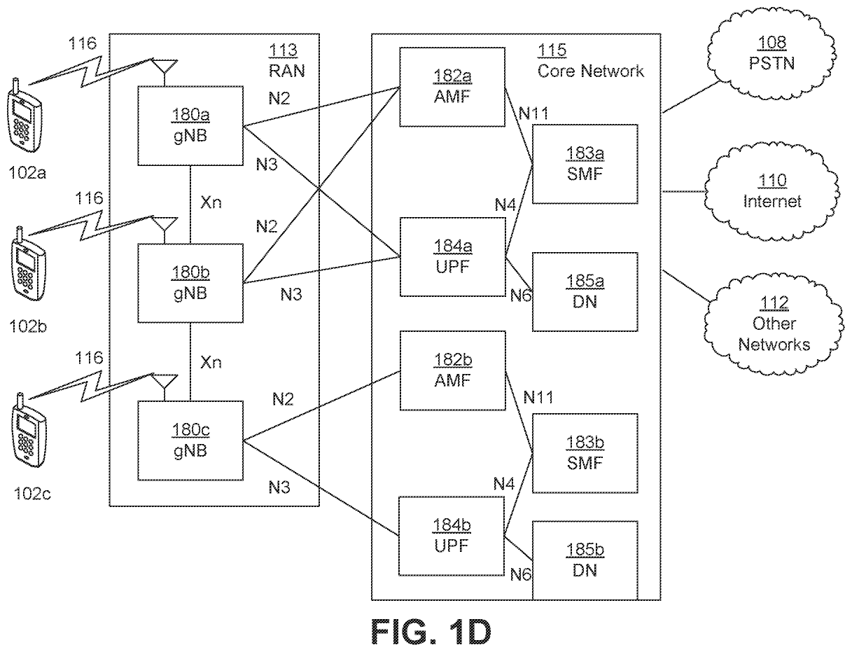

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to a time, a time period, tracking the time, tracking the period of time, etc. Reference to a timer expiration herein may refer to determining that the time has occurred or that the period of time has expired.

Transmission in unlicensed channels may be for controlled environments (e.g., may be limited to controlled environments). There may be an assumption in a controlled environment that the likelihood of a competing network and/or radio access technology (RAT) operating in the vicinity is low.

Frame-based equipment (FBE) may be used in controlled environments, for example, to better control the timing of listen-before-talk (LBT) throughout a network. FBE may use simpler LBT (e.g., LBT Type 2). FBE may support (e.g., enable) synchronization of LBT occasions (e.g., during the idle period of a fixed frame period (FFP)).

A WTRU may be configured with an FFP for gNB channel initiation and/or an FFP for WTRU channel initiation. An FFP configuration (e.g., once used and/or activated) may not be changed (e.g., for at least 200 ms). An FFP may include an idle period and a period where transmission is possible.

In examples of FBE deployments, a channel for an ongoing FFP may not be acquired by a node at one or more times and/or there may be a gap greater than 25 ms in a channel occupancy time (COT). in such cases, one or more resources (e.g., available resources) may be unused and/or wasted.

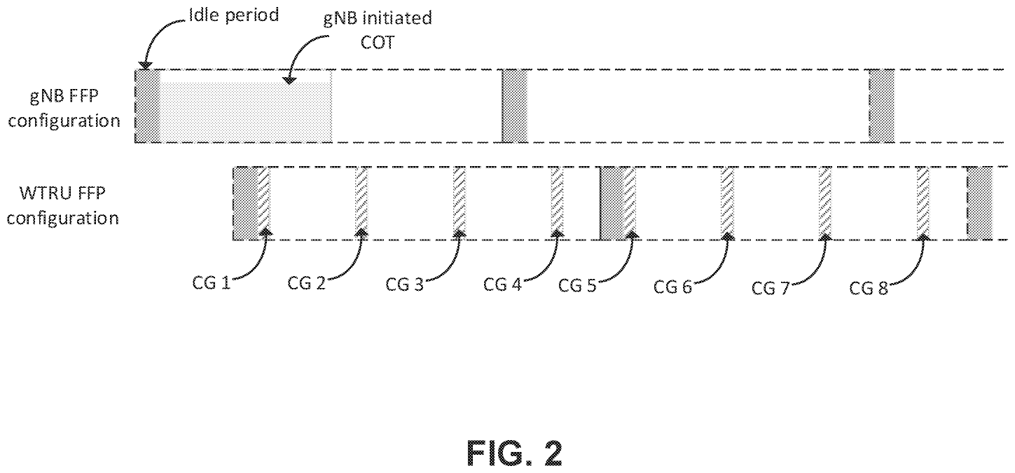

FIG. 2 illustrates an example of gNB and WTRU FFP configurations.

An FFP used by a WTRU may be changed, for example, once (e.g., only once) for a period of time (e.g., once every 200 ms). A WTRU may transmit (e.g., immediately) based on initiating a COT in an FFP. A configured UL transmission resource may match the timing of the beginning of an FFP (e.g., cell grant (CG) 1 and CG 5 as shown in FIG. 2). Additional configured transmission occasions may be enabled for a WTRU, for example, by using a smaller FFP duration, which may lead to increased resource loss (e.g., due to more idle periods). WTRUs with high priority data may transmit in configured resources configured at multiple times within an FFP, e.g., as described herein.

A WTRU may not initiate a COT at the beginning of an FFP (e.g., prior to CG 5). The WTRU may obtain ultra-reliable and low latency communication (URLLC) traffic later in the FFP to transmit (e.g., prior to CG 6). The WTRU may transmit in a later CG resource, for example, if the gNB initiated a COT. CG 8 may be available if the gNB initiates a COT in the third gNB FFP. The gNB may not initiate COTs just so a WTRU might use a CG. Forcing a WTRU to wait until the next FFP to initiate a COT may affect transmission latency.

A WTRU may have low priority data that collides with high priority data (e.g., at CG 1). The WTRU may use a CG associated with an FFP configuration for high priority data (e.g., CG 1). The WTRU may acquire the channel to transmit later in the FFP (e.g., at CG 3) as described herein, for example, depending on whether there is a gap in the COT (e.g., and/or depending on the size of the gap in the COT).

In examples, a device may be load based equipment (LBE) if responding (e.g., for DL initiated transmissions) and may be FBE, for example, if initiating (e.g., for UL initiated transmissions).

A WTRU in IDLE/INACTIVE mode may or may not have FFP configurations.

Latency and/or spectral efficiency may be unnecessarily increased, for example, if the WTRU waits until a future FFP start time to transmit UL data due to there being no active COT. Shortening the FFP periodicity may decrease latency at a cost of additional IDLE periods that may decrease spectral efficiency.

Resources may be used efficiently in a primarily FBE network. Systems, methods, and instrumentalities are described herein for enhanced channel access.

Resources may be configured to enable load-based equipment (LBE) access in an otherwise frame-based equipment (FBE) network. LBE access may be, for example, LBT category four (Cat 4). A wireless transmit/receive unit (WTRU) may determine whether an LBE resource is valid based on current channel occupancy. A WTRU may use an LBE resource as a function of a transmission priority (e.g., priority of the content of the transmission, for example a first PUSCH transmission may be associated with a first priority and a second PUSCH transmission may be associated with a second priority), transmission type (e.g., whether the transmission is for PUSCH or PUCCH, for DG-PUSCH or CG-PUSCH, for data or CSI or HARQ-ACK, etc.), requirement(s), and/or grant. A WTRU may use an LBE resource, for example, as a fallback resource. A WTRU may report measurements and/or may request to use LBE resources. A WTRU may be configured (e.g., with one or more restrictions) on when to use LBE resources and/or the type of listen-before-talk (LBT) to use for LBE resources. A WTRU may use LBE resources for random access (RA) and/or to avoid reconfiguration ambiguity.

Feature(s) described herein may be used to identify the availability for LBE operation in an FBE environment. A WTRU may identify the availability of resource(s) for an LBE transmission. A subset of resources may be reserved for LBE operation in an FBE environment. Examples of resources that may be reserved for LBE operation in an FBE environment may include one or more of the following: a time period, a frequency, or a bandwidth part. A WTRU may alternate (e.g., periodically alternate) between LBE and FBE operation over time (e.g., every X frames, subframes, slots, and/or symbols). A subset of frequencies, component carriers, and/or bandwidth parts may be reserved for LBE-based operation.

The ability to perform LBE operation in an FBE environment may be subject to one or more restrictions based on, for example, a channel, cell, and/or carrier type. Examples of a channel, cell, or carrier type may include one or more of the following: a beam, a UL type (e.g., supplementary uplink (SUL) or a normal/non-supplementary uplink (NUL)), a cell type, and/or a channel type. A subset of one or more beams may be associated with an LBE operation. A WTRU may be restricted to perform an LBE operation on (e.g., only on) the supplementary uplink or the normal uplink. Restriction(s) may be, for example, independently or jointly configured. A WTRU may perform LBE (e.g., only) on a secondary cell (SCell) while maintaining FBE operation on a primary cell (PCell), a primary SCell (PsCell), and/or a primary cell of a master or a secondary cell group, which may be referred to as a special cell (SpCell). A WTRU may perform LBE operation (e.g., only) on a PCell, PsCell, and/or SpCell while performing FBE operation on the SCell. The WTRU may use LBE operation for channels or operations, such as a random access channel (RACH).

An indication of resources and/or activation or deactivation for LBE transmission may be provided (e.g., sent) and/or received. In examples, resources and/or restrictions (e.g., additional restrictions) may by dedicated to a WTRU or to a subset of WTRUs. LBE operation may be configured, for example, semi-statically. A configuration may be indicated via unicast signaling (e.g., via radio resource control (RRC) signaling). In examples, LBE operation on a set of indicated resources may be enabled or disabled (e.g., enabled or disabled dynamically) via a MAC control element (CE) or downlink control information (DCI).

Examples of information included in signaling may be the resource(s) available for LBE operation (e.g., a duration and periodicity in time and/or a subset or range of frequencies), and/or the current capability of LBE operation (e.g., configured as “enabled” or “true” if/when LBE operation is possible and/or “disabled” or “false” if/when not possible on the indicated resource). Enablement, activation, selection, or operation of LBE operation may be configured (e.g., jointly configured) for time and frequency. For example, a parameter (e.g., one parameter) may control whether a WTRU may operate in LBE (e.g., LBE only within the indicated frequencies and time period). In some examples, the time/frequency resources may be independently or separately configured (e.g., with a dedicated parameter).

The availability of LBE operation may be indicated and/or enabled, for example, per-bandwidth part (BWP). An RRC parameter (e.g., “LBEOperationEnabled”) may be included in one or more of the following: information element(s) such as BWP, BWP-Downlink, or BWP-DownlinkCommon for downlink operation. Configuration for UL operation may be included via information elements BWP-Uplink and/or BWP-UplinkCommon. A parameter (e.g., “LBEOperationEnabled”) may be configured as “enabled” or “true,” for example, if LBE operation is possible (e.g., permitted) on the bandwidth part or may be configured as “disabled” or “false” if not possible (e.g., not permitted).

Dynamic signaling (e.g., via MAC CE and/or DCI) may indicate one or more of the following: a set of pre-configured resources are enabled or disabled or a modification of configured resources, such as a frequency range and/or a time duration/periodicity. Signaling may be dedicated to one or more WTRUs (e.g., a subset of WTRUs). A MAC CE and/or a DCI may include identifying information, such as indication(s) about which WTRUs the information may be applicable to (e.g., one or more cell radio network temporary identifiers (C-RNTIs) and/or a dedicated RNTI which may be dedicated to signaling whether LBE resource(s) are enabled or disabled)).

In examples, LBE operation may be available to multiple WTRUs (e.g., all WTRUs) within a cell. Available resource(s) and/or restriction(s) may be broadcast via system information. LBE and/or FBE transmission may be indicated for a subset of resources. A cell may alternate between FBE and LBE operation for one or more resources (e.g., all resources). FBE and LBE operation may be indicated to one or more WTRUs (e.g., all WTRUs) within a cell via system information. System information may include one or more parameters (e.g., to control available resources, restrictions, type of operation, and/or the like), such as a parameter “EquimentConfiguration,” which may include one or more values such as “FBEOperation,” “LBEOperation,” “Normal Operation,” and/or “Spare.”

An indication of channel availability for LBE transmission may be based on a COT. In examples, a node (e.g., gNB or WTRU) may acquire a channel and indicate that all or a portion of the channel is available for LBE operation. A node may signal which portion of a COT is available for LBE operation, for example, based on (e.g., in response to) acquisition of the channel by the node (e.g., gNB or WTRU). A slot format indication may be sent or received, indicating whether one or more resources are LBE or FBE (e.g., which may be in addition to indicating whether one or more resources are UL, DL or flexible).

A node (e.g., that acquired a channel) may send an indication that the remainder of the channel is available for LBE operation. Information provided in an indication may include, the remaining duration of the COT and/or the priority with which the channel was acquired.

WTRU monitoring may be provided (e.g., configured and/or implemented). A WTRU may have multiple physical downlink control channel (PDCCH) monitoring configurations. A WTRU may use a first PDCCH monitoring configuration, for example, if there is no ongoing COT. The first PDCCH monitoring configuration may have monitoring occasions at the beginning of the gNB's FFP (e.g., only at the beginning of the gNB's FFP). A WTRU may not monitor for a PDCCH transmission for the remainder of the FFP based on determining that the gNB has not initiated a COT. A WTRU may utilize (e.g., switch to) a second PDCCH monitoring configuration, for example, if the WTRU determines that the gNB initiated a COT in a gNB FFP. The WTRU may utilize (e.g., switch to) the first PDCCH monitoring configuration at the end of a gNB's FFP and/or based on an indication received from the gNB.

A WTRU may monitor for an indication, such as the presence of a trigger signal. A trigger signal may indicate to the WTRU that LBE resource(s) may be used for a UL transmission. In examples, a WTRU (e.g., using the first PDCCH monitoring configuration) may monitor for the presence of a trigger signal. A WTRU may have multiple monitoring occasions within an FFP to monitor for a trigger. In examples, the WTRU may monitor for a trigger signal if using the second PDCCH monitoring configuration.

A WTRU may use an LBE resource, for example, if (e.g., only if) the WTRU is using (e.g., currently using) the first PDCCH monitoring configuration. A WTRU may use an LBE resource if the WTRU is using the second PDCCH monitoring configuration and the WTRU receives an indication from the gNB that LBE resource(s) are valid.

A WTRU may switch to a second PDCCH monitoring configuration based on initiating a COT (e.g., using LBE or FBE channel access techniques).

A WTRU may switch to LBE operation based on one or more triggers (e.g., activation trigger(s)). A trigger may be or may be based on, for example, a grant, a transmission type, a current use of a COT, performance of a previous channel acquisition attempt, etc.

A WTRU may switch to LBE operation based on a grant. A WTRU may switch between LBE and FBE channel access type and/or operation as a function of (e.g., based on) one or more of the uplink grant, a property of the grant, the DCI that scheduled the grant, the contents of the grant, and/or the like.

In examples, a WTRU may be configured and/or predetermined to use an LBT of FBE channel access for configured grants, dynamic grants, and/or a subset of configured grants. A WTRU may be configured, for example by higher layer(s) (e.g., RRC), with an ability to use LBE (e.g., in addition to FBE) for a channel access operation type. A configuration (e.g., to use FBE and/or LBE) may be for one or more (e.g., all) configured grants or may be on per configured grant basis. A WTRU may be (pre)configured and/or (pre)determined with an ability to use LBE (e.g., in addition to FBE) for a channel access operation type. A configuration (e.g., to use FBE and/or LBE) may be provided, for example, via a physical random access channel (PRACH) resource, a physical uplink control channel (PUCCH) resource, and/or a type of control information.

In examples, a WTRU may determine the channel access types (e.g., FBE and/or LBE) and/or switch between the channel access types based on a property of the grant. A property of a grant may include one or more of the following: bandwidth part, carrier, transmission duration, physical uplink shared channel (PUSCH) start or end time, numerology, or priority index associated with the grant. A WTRU may use LBE channel access for a configured grant, for example, if the LBE channel access ends before the next IDLE period. A WTRU may use LBE channel access if the configured grant is in a bandwidth part configured for LBE and FBE channel access. A WTRU may use LBE channel access if the duration of the grant is less than a threshold and/or less than the remaining time in a COT acquired by another WTRU or another gNB in the network.

In examples, the WTRU may determine the channel access type (e.g., FBE and/or LBE) and/or switch between channel access types based on reception of an indication or a DL transmission prior to a channel access opportunity. A WTRU may switch to LBE, for example, if the WTRU received an indication (e.g., via a DCI or MAC CE) to do so (e.g., in the same maximum channel occupancy time (MCOT)) and/or if the LBT is performed before the next IDLE period for FBE. A WTRU may determine the channel access type (e.g., FBE and/or LBE) and/or switch between channel access types based on a property of the DCI (e.g., PDCCH control resource set (CORESET), search space, and/or format). A WTRU may determine (e.g., that it is permitted) to use LBE channel access for a predefined and/or configured period of time, for example, after receiving an indication. A WTRU may (e.g., based on reception of an indication) start a timer. The WTRU may use LBT channel access while the timer is running. The WTRU may revert to FBE, for example, based on the expiry of the timer (e.g., or visa-versa). A WTRU may (e.g., based on reception of an indication) use LBE channel access, for example, for one or more grants and/or uplink transmissions (e.g., all grants and/or uplink transmissions) that may be included in a predefined period from the reception of the indication or until the next FBE IDLE period.

A WTRU may be configured (e.g., receive configuration information) with grants assigned to a channel access technique (e.g., FBE and/or LBE). In examples, a WTRU may have a set of LBE configured grants (e.g., resource(s) associated with a second operating condition) and/or a set of FBE configured grants (e.g., resource(s) associated with a first operating condition). FBE configured grants may be used (e.g., available data may be transmitted in an FBE CG resource as described herein) if located at the beginning of a WTRU FFP (e.g., a period) and the WTRU initiates (e.g., successfully initiates) a COT (e.g., using one or more FBE channel access techniques) or if the gNB initiated a COT that overlaps the FBE CG. An LBE CG may be used if the WTRU initiates (e.g., successfully initiates) a COT (e.g., using an LBE channel access technique), if the WTRU previously initiated a still-active COT (e.g., using one or more FBE channel access methods), or if the gNB initiated a COT that overlaps the LBE CG resource. An LBE CG may be considered valid (e.g., the LBE CG may be used by the WTRU) if the LBE CG has achieved one or more of the criteria described herein.

A WTRU may switch to LBE operation based on a transmission type. In examples, a WTRU may determine a channel access type (e.g., FBE and/or LBE) and/or may switch between channel access types based on a property of the data and/or control information to be transmitted. A WTRU may be configured, for example by higher layer(s) (e.g., RRC). A WTRU may be configured per logical control channel (LCH), e.g., with an “LBE permitted” parameter. A WTRU may be (pre)configured and/or (pre)determined with an “LBE permitted” parameter per data radio bearer (DRB), signaling radio bearer (SRB), and/or MAC CE. A WTRU may use LBE channel access if the WTRU has buffered data for transmission (e.g., to be transmitted once the channel is obtained by the WTRU). Buffered data may be multiplexed in the PDU for transmission. A WTRU may use LBE channel access if one or more multiplexed bit(s) to be transmitted are from an LCH, DRB, SRB, or MAC CE configured with, or (pre)determined with, “LBE permitted.” A WTRU may use FBE channel access, for example, if one or more multiplexed bit(s) to be transmitted are from an LCH, DRB, SRB, or MAC CE configured with, or (pre)determined with, “FBE permitted”. In examples, a WTRU may be configured with per LCH/DRB/SRB/or MAC CE with “LBE only” or “FBE only” configurations. Bits from LCHs/DRBs/SRBs/or MAC CEs may be multiplexed in the PDU. The WTRU may use (e.g., only use) LBE channel access for PDUs that include bits from an LCH, DRB, SRB, or MAC CE configured with “LBE only”. The WTRU may use (e.g., only use) FBE channel access for PDUs that include bits from an LCH, DRB, SRB, or MAC CE configured with “FBE only”.

A WTRU may determine a channel access type (e.g., FBE and/or LBE) and/or switch between channel access types, for example, based on a transport block size (TBS) and/or QoS of the data multiplexed in the PDU for transmission. A WTRU may switch to LBE or FBE, for example, if the transport block size of the PDU and/or the amount of buffered data is less than or greater than a (pre)configured and/or (pre)determined threshold or is within a (pre)configured and/or (pre)determined range. A WTRU may switch to LBE if the amount of buffered data exceeds a TBS of a PUSCH resource (e.g., which may be configured following an FBE IDLE period). A WTRU may switch to LBE (or FBE) if the QoS of the data cannot be met (e.g., using available resources configured for FBE (or LBE) channel access). For example, the WTRU may have buffered data that cannot be transmitted on PUSCH resources immediately following an FBE IDLE period (e.g., a configured grant after the IDLE period), which may be due to configured logical channel prioritization (LCP) and/or logical channel (LCH) mapping restrictions for the buffered data. The WTRU may use an LBE channel access to request a grant (e.g., transmit a scheduling request (SR)) or to transmit the buffered data on different available PUSCH resources (e.g., resource(s) not attainable with FBE channel access). In examples, a WTRU may determine the channel access type from the QoS flow ID (QFI) tag associated with the PDU to be transmitted. A WTRU may be configured with a mapping table between QFIs and channel access types. A WTRU may determine the QFI based on a received DL transmission (e.g., data or control including when reflective QoS is configured).

In examples, a WTRU may determine the channel access type (e.g., FBE and/or LBE) and/or may switch between channel access types based on the channel or a property of the channel used to initiate channel access (e.g., PUSCH, PRACH, or PUCCH). A WTRU may be (pre)configured and/or (pre)defined per channel (e.g., PUSCH, PRACH, or PUCCH) with channel access type(s) (e.g., FBE and/or LBE). A WTRU may use FBE and/or LBE (e.g., accordingly) to initiate channel access, for example, if the uplink channel is configured with the access type. A WTRU may be (pre)configured and/or (pre)defined per uplink control information (UCI) type (e.g., hybrid automatic repeat request acknowledgement (HARQ-ACK), SR, sounding reference signal (SRS), etc.) with a permissible channel access type (e.g., FBE and/or LBE). A WTRU may be (pre)configured and/or (pre)defined with an indication whether the WTRU can initiate channel access to transmit a UCI using FBE and/or LBE.

A WTRU may switch to LBE operation based on the use (e.g., current use) of a COT. In examples, a WTRU may determine a channel access type (e.g., FBE and/or LBE) and/or may switch between channel access types, for example, based on a function of the time gap between the last reception in a COT (e.g., a DL signal or transmission or a UL signal from another WTRU) and a subsequent transmission. The last reception in a COT may be, for example, one or more of the following: a downlink received signal; or a received signal transmitted by another WTRU in the network (e.g., a COT sharing signal or an end of an uplink transmission). A WTRU may use LBE channel access if the time since the last DL reception, or since the last COT end signal was received (e.g., indicating that the COT associated with the first operating condition has ended), is larger than (e.g., exceeds) a (pre)determined and/or (pre)configured threshold.

In examples, a WTRU may determine a channel access type (e.g., FBE and/or LBE) and/or may switch between channel access types based on (e.g., as a function of) the time gap since the last channel access opportunity (e.g., the last IDLE period or the last failed LBT attempt). A WTRU may use LBE channel access, for example, if the time since the last IDLE period or failed LBT on an FBE opportunity has exceeded a threshold (e.g., configured threshold). A WTRU may switch channel access types or use LBT channel access, for example, if the time between the LBT attempt and the next IDLE period (e.g., in a following period) is less than or greater than a (pre)determined and/or (pre)configured threshold and/or if the uplink transmission terminates before the next IDLE period.

A WTRU may switch to LBE operation based on performance of one or more previous channel acquisition attempts. A WTRU may determine the channel access type (e.g., FBE and/or LBE) or switch between channel access types, for example, based on the (re)-transmission number and/or attempt associated with the transport block. A WTRU may use LBE channel access to retransmit a TB, for example, after a configured number of retransmissions, after a number (e.g., configured number) of LBT failures, and/or after a number or a percentage of failed attempts on channel access opportunities associated with FBE. In examples, a WTRU may maintain an LBT failure counter, which may be updated based on failing LBT for an uplink transmission (e.g., any uplink transmission conditioned on FBE channel access opportunities). A WTRU may start a timer based on a counted LBT failure (e.g., each counted LBT failure). A WTRU may clear an LBT counter and/or switch channel access type (e.g., use LBE channel access) based on timer expiry. A WTRU may determine a consistent LBT failure, for example, if the LBT failure counter is above a configured threshold. A WTRU may switch channel access type (e.g., use LBE channel access), for example, if the LBT failure counter is above a configured threshold. In examples, a WTRU may use an (e.g., a consistent) LBT failure counter and timer mechanism, e.g., in the MAC layer, to control switching between FBE and LBE channel access. A WTRU may switch to LBE channel access after triggering an (e.g., a consistent) uplink LBT failure. A WTRU may (e.g., attempt to) perform channel access using LBE, for example, prior to taking other recovery actions (e.g., switching BWPs and/or sending an SR). A WTRU may perform one or more recovery actions (e.g., as described herein) based on failing LBT using LBE after switching from FBE (e.g., for a configured number of times). A WTRU may multiplex an LBT failure MAC CE in the PDU after detecting an (e.g., a consistent) uplink LBT failure. The MAC CE may indicate the failure on FBE channel access opportunities. In examples, the WTRU may maintain multiple LBT failure counters and/or timer (e.g., two LBT failure counter and/or times such as one for LBE and another for FBE). A counter and/or time (e.g., each counter and/or time) may be updated, for example, based on LBT failure on LBE or FBE, respectively. The WTRU may maintain multiple procedures (e.g., two procedures) for detecting a (e.g., consistent) UL LBT failure (e.g., one for LBE and another for FBE).

There may be a fallback resource. A WTRU may start a timer, for example, after using LBE channel access or switching from FBE to LBE. The WTRU may fall back to FBE-only channel access based on expiry of the timer. The WTRU may fall back to FBE channel access, for example, after a configured number of passed IDLE periods and/or after a number of failed channel access attempts in LBE.

A WTRU may be configured with one or more rules to associate a channel access type to a data or control priority level (e.g., determined, configured, and/or selected data or control priority level). A WTRU may transmit priority data (e.g., high priority data) during an FBE occasion and use an LBE occasion to transmit priority data (e.g., low priority data) that was dropped and/or deprioritized, for example if there was a collision between priority data (e.g., high and low priority data).

An indication of channel availability for LBE operation may be implicit. A WTRU may be configured with resources on which it may transmit using LBE channel access methods, e.g., with the resources deemed as LBE resources. A WTRU may use LBE resources, for example, if they occur within a COT, e.g., without using LBE channel access methods. A WTRU may use LBE resources if the LBE resources do not occur within a gNB initiated COT. A WTRU may use LBE resources if they do not occur within a COT initiated with FBE channel access techniques (e.g., initiated by either a gNB or WTRU).

A WTRU may determine whether the WTRU may perform LBE channel access to initiate a COT to transmit on LBE resources, for example, as a function of a timer. A WTRU may perform LBE channel access to initiate a COT to transmit on LBE resources if the timer is active or expired. A timer may be started or restarted as a function of, for example, one or more of the following: a COT structure, the time of the last received transmission, the time of the last successful WTRU COT initiation, the time of the last successful gNB COT initiation, the time since the last UL transmission, or the time since the last WTRU COT initiation.

A timer may be started or restarted as a function of a COT structure. For example, a WTRU may start or restart a timer at the end of a COT.

A timer may be started or restarted as a function of the time of the last received transmission. For example, a WTRU may start or restart a timer after receiving a DL transmission (e.g., DL channel or signal).

A timer may be started or restarted as a function of the time of a last successful WTRU COT initiation. For example, a WTRU may start or restart a timer if the WTRU initiates a COT. In examples, a WTRU may start or restart a timer if the WTRU initiates a COT with FBE channel access (e.g., at the beginning of an FFP). In examples, a WTRU may start or restart a timer if the WTRU initiates a COT with LBE channel access.

A timer may be started or restarted as a function of the time of a last successful gNB COT initiation. A WTRU may start or restart a timer at the beginning of a gNB FFP, for example, if the gNB initiates a COT at that time.

A timer may be started or restarted as a function of the time since the last UL transmission. For example, a WTRU may start or restart a timer if the WTRU performs a UL transmission. A WTRU may start or restart a timer if the WTRU performs a UL transmission using an FBE channel access technique. In examples, a WTRU may start or restart a timer if the WTRU performs a UL transmission using an LBE channel access technique.

A timer may be started or restarted as a function of time since the last WTRU COT initiation. For example, a WTRU may start or restart a timer if the WTRU initiates a COT using FBE channel access techniques. In examples, a WTRU may start or restart a timer if the WTRU initiates a COT using LBE channel access techniques.

A WTRU with FBE and LBE resources (or resources that can be used for FBE and LBE transmission) may determine which to use, for example, as a function of the gap between a previous UL or DL transmission and its UL transmission resource. For example, a WTRU may receive scheduling for a UL transmission in an upcoming resource that can use LBE channel access. The WTRU may determine the gap duration between the last transmission prior to the scheduled UL resource and its scheduled UL resource. The last transmission prior to the scheduled UL resource may be a DL transmission or a UL transmission. The WTRU may use channel access determined by the parameter(s) of an ongoing COT, for example, if the gap is less than a threshold. The WTRU may use an LBE channel access technique (e.g., using an LBE resource) if the gap is greater than a threshold.

A WTRU may (e.g., determine to) transmit using an LBE resource as a function of the timing of an upcoming WTRU or gNB FFP. A WTRU may not use LBE channel access on an LBE resource if the difference in time between the LBE resource and an upcoming WTRU IDLE or WTRU FFP start time is less than a threshold value. A WTRU may not use LBE channel access on an LBE resource, for example, if the difference in times between the LBE resource and an upcoming gNB IDLE or gNB FFP start time is less than a threshold value.

WTRU reporting may be provided and/or received (e.g., by a gNB). In examples, a WTRU may determine one or more performance metric(s) applicable to LBE and/or FBE operation. The WTRU may report the metric(s), for example, using physical layer, MAC CE, and/or RRC signaling.

A variety of types of metric may be reported. Reporting may be triggered. A metric may include, for example, the number of times the WTRU failed to access the channel for a specific period or number of attempts (e.g., determined, selected, and/or configured period or number of attempts). A metric may be expressed, for example, as a number or as a percentage.

A metric may include statistic(s) of access delay (e.g., average or maximum). An access delay may be defined as the time between the time data is available for transmission and the time at which a transport block including the data may be transmitted. A metric may be applicable to type(s) (e.g., specific types such as configured, selected, and/or determined) of grant(s), such as a configured grant (e.g., only to a specific type of grant). A transmission may be an initial transmission of a transport block.

A metric may include a channel occupancy measurement and/or a received signal strength indicator (RSSI) taken during one or more periods of time. A channel occupancy measurement may include a percentage of values beyond a threshold.

Periods of time in which a WTRU may measure samples for a metric may be configured, for example, by higher layers. Periods of time may include a set of periodically recurring intervals of configured duration with a configured periodicity.

A WTRU may be configured to report a metric, for example, periodically (e.g., with a configured periodicity) and/or if the metric becomes lower or higher than a (e.g., configured threshold). Multiple metrics may be configured, determined, selected, etc. A WTRU may report metrics, for example, if a first metric becomes higher than a second metric (e.g., plus an offset, such as a configured offset).

A metric may pertain to an access type. A metric (e.g., as described herein) may pertain to an access type, such as an LBE or FBE operation. The periods may be dependent on an access type (e.g., each access type). In examples (e.g., for an FBE access type), periods may include idle periods. In examples (e.g., for an LBE access type), periods may include the time during which a WTRU measures a channel during listen-before-talk. A metric may include access delay statistics. For example, access delay samples for a metric pertaining to an access type may include (e.g., only) samples taken while the WTRU is operating using the same access type. A parameter, threshold, and/or configuration used for the calculation of a metric or for triggering reporting of the metric may be configured separately (e.g., for each of multiple access types).

A WTRU may report a metric pertaining to the same access type as the access type the WTRU is operating with at the time of transmission of the report. A WTRU may be configured to report metrics for each of multiple access types.

A metric may pertain to a channel acquisition state. A metric may depend on measurement(s) restricted to time periods in which the channel is (or is not) acquired by the gNB and/or the WTRU. Differentiation (e.g., between nodes such as the gNB and WTRU) may be used to determine the presence of out-of-network or out-of-gNB interference. For example, a WTRU may determine that a first channel occupancy ratio may pertain to periods while the network has acquired the channel (e.g., initiated a COT or acquired an FFP) and a second channel occupancy ratio may pertain to periods while the network has not acquired the channel. The WTRU may determine whether the network acquired the channel for a given period, for example, based on detecting a synchronization signal block (SSB) or other reference signal.

The WTRU may take measurement samples (e.g., at pre-determined times) and may receive (e.g., subsequently receive) signaling indicating which samples were taken while the channel was acquired or may receive the periods of time during which the channel was acquired. A parameter, threshold, and/or configuration (e.g., any parameter, threshold, and/or configuration) used for the calculation of the metric and/or for triggering reporting of the metric may be configured separately (e.g., for each channel acquisition state).

A change of access type may be triggered by measurement(s). A WTRU may determine a change of access type, such as from FBE to LBE or vice-versa, for example, if a metric becomes higher or lower than a configured threshold. A WTRU operating using an FBE access type may change the access type to LBE if an access failure metric becomes higher than a threshold. A WTRU operating using an FBE access type may change the access type to LBE if an access delay metric becomes higher than a threshold. A WTRU operating using an LBE access type may change the access type to FBE if a channel occupancy metric becomes higher or lower than a threshold. A threshold may be configured by higher layers. One or more thresholds for determining a change of access type may be the same as one or more thresholds used for determining when to trigger transmission of a report including at least one metric.

A WTRU may report the value of one or more metrics, for example, if the WTRU determines a change of access type. A WTRU may report the value of a metric if a change of access type is triggered by the metric becoming higher or lower than a threshold.

WTRU monitoring may be provided (e.g., configured and/or implemented). A WTRU may have multiple physical downlink control channel (PDCCH) monitoring configurations. A WTRU may use a first PDCCH monitoring configuration, for example, if there is no ongoing COT. The first PDCCH monitoring configuration may have monitoring occasions at the beginning of the gNB's FFP (e.g., only at the beginning of the gNB's FFP). A WTRU may not monitor for a PDCCH transmission for the remainder of the FFP based on determining that the gNB has not initiated a COT. A WTRU may utilize (e.g., switch to) a second PDCCH monitoring configuration, for example, if the WTRU determines that the gNB initiated a COT in a gNB FFP. The WTRU may utilize (e.g., switch to) the first PDCCH monitoring configuration at the end of a gNB's FFP and/or based on an indication received from the gNB.

A WTRU may monitor for an indication, such as the presence of a trigger signal. A trigger signal may indicate to the WTRU that LBE resource(s) may be used for a UL transmission. In examples, a WTRU (e.g., using the first PDCCH monitoring configuration) may monitor for the presence of a trigger signal. A WTRU may have multiple monitoring occasions within an FFP to monitor for a trigger. In examples, the WTRU may monitor for a trigger signal if using the second PDCCH monitoring configuration.

A WTRU may use an LBE resource, for example, if (e.g., only if) the WTRU is using (e.g., currently using) the first PDCCH monitoring configuration. A WTRU may use an LBE resource if the WTRU is using the second PDCCH monitoring configuration and the WTRU receives an indication from the gNB that LBE resource(s) are valid.

A WTRU may switch to a second PDCCH monitoring configuration based on initiating a COT (e.g., using LBE or FBE channel access techniques).

LBE operation in an FBE environment may be subject to one or more conditions or restrictions. The network may partition WTRUs into FBE WTRUs, LBE WTRUs, and hybrid WTRUs (e.g., supporting FBE and LBE LBT). In examples, a WTRU operating in an FBE environment may transmit a UL transmission using the LBE LBT, e.g., if permitted by the network. One or more conditions may prevent or allow a WTRU operating in an FBE environment to use LBE LBT, e.g., as well as one or more restrictions (e.g., parameter restrictions) applicable to use of LBE LBT.

LBE LBT restrictions may be based on one or more rules and/or conditions (e.g., predetermined rules and/or conditions). A WTRU may be allowed to or not allowed to transmit a UL transmission according to LBE LBT (e.g., while operating in FBE environment), for example, based on one or more of the following conditions: whether a priority of the intended UL transmission is above or below a configured priority value; or the transmission time of the intended UL transmission.

A WTRU may be allowed to or not allowed to transmit a UL transmission according to an LBE LBT (e.g., while operating in an FBE environment), for example, if a priority of the intended UL transmission is above a configured priority value. A WTRU may be configured to use LBE LBT (e.g., only LBE LBT) for the highest priority transmission(s). A set of priority values may allow a WTRU to use LBE LBT. A WTRU may determine the priority of a UL transmission based on one or more corresponding logical channel prioritization (LCP) procedures.

A WTRU may be allowed to or not allowed to transmit a UL transmission according to LBE LBT (e.g., while operating in an FBE environment) based on the transmission time of the intended UL transmission. A WTRU may be configured to not use LBE LBT in one or more of the following: if the transmission time of the intended UL transmission overlaps partially or entirely with an idle period of a gNB's FFP and/or an idle period of the WTRU's FFP; if the transmission time of the intended UL transmission overlaps partially or entirely with a window of x micro-seconds before the start of the gNB's FFP and/or the start of the WTRU's FFP; or if the transmission time of the intended UL transmission overlaps partially or entirely with (e.g., (pre)configured) reserved slots and/or symbols (e.g., the gNB may pre-configure a WTRU with a set of slots/symbols on which LBE LBT is not allowed).

An LBE LBT restriction may be based on an indication (e.g., explicit indication) from a network. In examples, a WTRU may receive an indication (e.g., explicit indication) from the gNB indicating that an LBE LBT may be available or not available. A WTRU may receive a group common DCI or a WTRU-specific DCI indicating that LBE LBT is available or not available for a set of slots/symbols, e.g., following the reception of the DCI. In examples, a WTRU may receive an indication using RRC signaling. The indication that LBE is available or not available may be valid per cell, per BWP, per frame(s)/sub-frame(s)/slot(s)/symbols(s), per subband, and/or per beam.

In examples, a WTRU may receive an indication de-activating an LBE LBT. An indication may be transmitted, for example, using RRC signaling or dynamic signaling (e.g., using a DCI or MAC CE).

An LBE LBT restriction may be based on an implicit indication. A WTRU may be configured to not transmit a UL transmission according to LBE LBT requirement(s), for example, based on an indication (e.g., implicit indication) from the gNB. A WTRU may determine it is not allowed to use FBE LBT, for example, based on a received FFP configuration (e.g., the gNB's FFP and/or WTRU's FFP). For example, an FFP configuration may have an idle period smaller than a threshold. In examples, a WTRU may determine whether to use or not use LBE LBT based on one or more WTRU capabilities.

An LBE LBT may have one or more parameter restrictions. In examples, a WTRU may be allowed to use LBE LBT. The WTRU may be configured to use LBE LBT with one or more restricted parameters. For example, a WTRU may be configured to use LBE LBT with (e.g., only) a subset of the set of parameters that are allowed to be used (e.g., as opposed to other LBE LBT techniques where a WTRU may be allowed to use LBE LTE with more/all of the set of parameters). A WTRU may be configured to use a subset of one or more of the following: channel access priority class (CAPC) values; contention window size (CWS); energy detection threshold(s); or energy detection duration(s).

A WTRU may be configured to use a subset of CAPC values. For example, a WTRU may be configured to use high CAPC values (e.g., only high CAPC values) when using LBE LBT in an FBE environment, which may reduce channel utilization (e.g., since a high CAPC value uses a smaller maximum channel occupancy time).

A WTRU may be configured to use a CWS during LBE LBT that does not exceed a configured threshold. For example, a WTRU may use (e.g., only use) a small CWS that does not result in overlapping with the idle period of FFP of the WTRU or the gNB. A WTRU may start with an initial CWS and monitor for clear channel assessment. The WTRU may detect that the channel is busy. The WTRU may stop using LBE LBT, for example, instead of increasing the CWS.

A WTRU may be configured to use a subset of one or more energy detection thresholds for LBE LBT. A WTRU may be configured to use a lower energy detection threshold, for example, if using LBE LBT in an FBE environment.

A WTRU may be configured to use a subset of an energy detection duration. A WTRU may be configured to use a shorter energy detection duration, for example, if using LBE LBT in an FBE environment.

Operation for IDLE/INACTIVE mode WTRUs may be determined and/or configured. Operation for IDLE/INACTIVE mode may be based on a RACH occasion LBT type determination. A WTRU may be configured with RA resources. A configuration may be received, for example, via an SSB, a master information block (MIB), a system information block (SIB), and/or an RRC configuration. An RA resource may be configured as FBE and/or LBE. A WTRU may transmit an RA preamble in an FBE RA resource if one or more of the following is true: the WTRU is configured with a WTRU FFP configuration and the WTRU has acquired the channel using an FBE channel access technique; or the WTRU determined that the gNB initiated a COT within which the FBE RA resource is located.

A WTRU may transmit an RA preamble in an LBE RA resource, for example, if one or more of the following is true: the WTRU acquired the channel using an LBE channel access technique; the WTRU determined that the gNB initiated a COT within which the LBE RA resource is located; or the WTRU determined that the gNB has not initiated a COT within which the LBE RA resource is located.

A WTRU may determine an applicable RA resource type (e.g., FBE and/or LBE) and/or the applicable channel access type (e.g., FBE and/or LBE) to use for an RA resource, for example, as a function of one or more of the following: a random access type (e.g., the WTRU may determine the channel access type based on whether it is a 4 or 2 step RACH process); whether the WTRU received a RACH order; whether the RA is contention-based or contention-free; whether the WTRU is in IDLE, INACTIVE or CONNECTED mode; the preamble sequence used (e.g., long or short); whether the RA is for a conditional handover (HO) or a regular HO; an indication from a gNB; or the RA trigger. For the RA trigger, a WTRU may have multiple triggers to perform an RA (e.g., one or more of initial access, handover, RRC connection re-establishment, time alignment establishment, request for SI, beam failure recovery, positioning, and/or the like). The WTRU may determine the applicable RA resource type (e.g., LBE and/or FBE) and/or the applicable channel access type (e.g., FBE and/or LBE) for an RA resource depending on the trigger.

A cell-specific configuration may be provided and/or received. A WTRU may be configured with a cell-specific FFP configuration. A WTRU may use the cell-specific FFP configuration, for example, if the WTRU (e.g., at initial access) has not received a full or complete WTRU-specific configuration. A cell-specific configuration may be applicable to one or more transmissions, for example, until the WTRU receives a WTRU-specific configuration. A WTRU may not be able to change FFP configuration before a minimum amount of time has elapsed (e.g., 200 ms). A WTRU may (e.g., during a reconfiguration period) may (e.g., be able to) use LBE resources and/or access the channel using LBE channel access techniques.

A WTRU may start a timer, for example, if the WTRU is being reconfigured with new FFP configurations. The WTRU may (e.g., while the timer is running) use LBE resources or access the channel using LBE channel access techniques.

In examples, a WTRU may not use LBE resources while a reconfiguration timer is running. A WTRU may use LBE resources if a WTRU FFP configuration has been active for an amount of time (e.g., 200 ms).

A WTRU may use an LBE resource and/or may acquire a channel using LBE channel access techniques to indicate to the gNB that the WTRU is using a new FFP configuration. The new FFP configuration may be associated with the resource on which or for which the WTRU performed LBE channel access. The WTRU may use an LBE resource and/or may acquire the channel using an LBE resource, for example, to indicate to the gNB that the WTRU may (e.g., determine to) change one or more WTRU FFP configurations (e.g., an active FFP configuration).

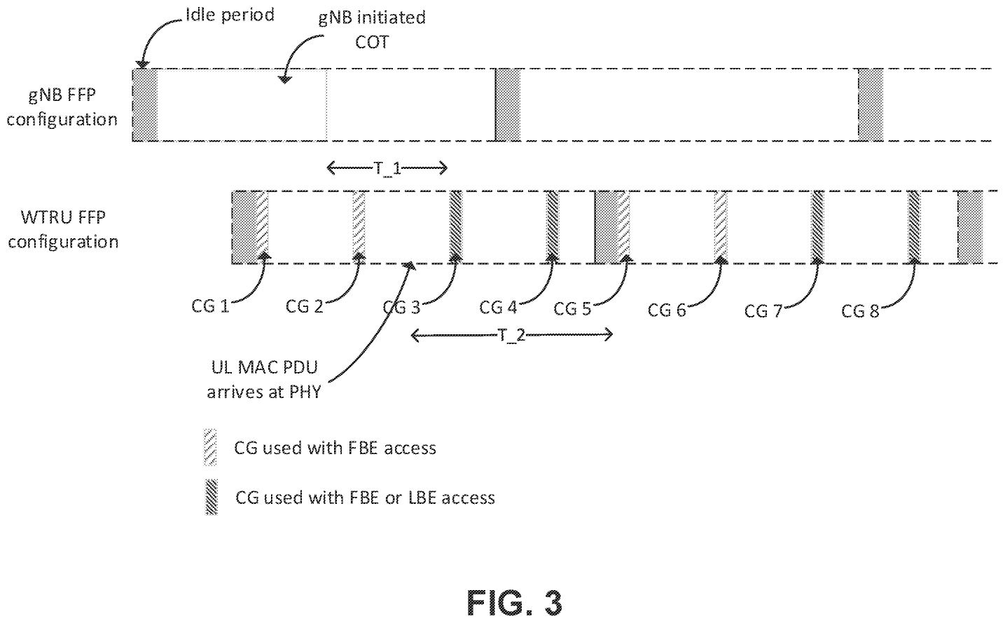

FIG. 3 illustrates an example of late arriving data, e.g., a late arriving MAC PDU (e.g., data may arrive after a gNB initiated COT has ended). FIG. 3 shows an example of a WTRU with data arriving in the middle of the WTRU's FFP configuration. As shown in FIG. 3, the WTRU did not transmit in resources overlapped by the gNB initiated COT, and the WTRU did not try to initiate a COT prior to CG1, for example, given that the WTRU did not have data at the beginning of the WTRU's FFP. The WTRU may not transmit the data in CG3 using FBE access techniques, for example, if the time between the end of the gNB initiated COT and CG3 (T_1) is greater than a threshold (e.g., the WTRU cannot share the gNB initiated COT to transmit via CG3 using FBE access techniques). The WTRU may (e.g., have to) wait until CG4 if the gNB initiates and shares a COT prior to CG4 and does not override the slot format. The WTRU may (e.g., have to) wait until CG5 to transmit its data if the WTRU is not able to use an LBE resource for channel access (e.g., CG3 or CG4 in FIG. 3). Waiting until CG5 may incur a latency of T_2.

The WTRU may be configured with CG resources on which the WTRU may use LBE channel access techniques (e.g., LBE resources). For example, CG3 and CG4 may be configured as LBE resources as shown in FIG. 3. The WTRU may perform an LBT and if the LBT is successful (e.g., the LBT action indicates that the channel is available, unused, etc.) initiate a COT prior to CG3 using LBE channel access techniques. The WTRU may determine to perform LBT/initiate a COT prior to CG3 using LBE channel access techniques, for example, based on one or more of the following: configuration of an LBE resource; reception of a trigger (e.g., activation trigger), for example from the gNB, enabling use of LBE resources; a determination that the channel is not currently occupied by a gNB initiated COT; the priority of the data to be transmitted; the reason why the transmission did not occur prior to the LBE resource; the performance of one or more previous channel access attempts using FBE and/or LBE channel access techniques; or the value of T_2 (e.g., the time between the arrival of the packet, for example at the physical layer (PHY) and the next WTRU FFP start time, or the time between the next available CG configured as LBE resource occurring after the arrival of the packet and the next WTRU FFP start time).

The WTRU may, based on the priority of the data to be transmitted, perform an LBT and if the LBT is successful initiate a COT, prior to CG3, e.g., using LBE channel access techniques. For example, the WTRU may use LBE resources to transmit the data, if the priority of the data to be transmitted is high (e.g., higher than a priority threshold). The WTRU may wait until CG4 if the priority of the data to be transmitted is low (e.g., lower than the priority threshold) and may transmit the data in CG4 if the gNB initiates a COT prior to CG4. The WTRU may wait and initiate a COT (e.g., perform an LBT and if the LBT is successful initiate the COT) for CG5 if the priority of the transmission is low (e.g., if the gNB did not initiate a COT prior to CG4)).

The WTRU may initiate a COT (e.g., perform an LBT and if the LBT is successful initiate the COT) prior to CG3 using LBE channel access techniques based on the reason why the transmission did not occur prior to the LBE resource. For example, a WTRU may use an LBE resource if the transmission was delayed due to a failed LBT attempt (e.g., for an FBE or an LBE resource).

The WTRU may initiate a COT (e.g., perform an LBT and if the LBT is successful initiate the COT) prior to CG3 using LBE channel access techniques based on the value of T_2 (e.g., the time between the arrival of the data packet, e.g., at the PHY layer, and the next WTRU FFP start time) being equal to or larger than a threshold. The WTRU may wait to transmit until CG5 (e.g., to use FBE channel access techniques), for example, if T_2 is smaller than the threshold.

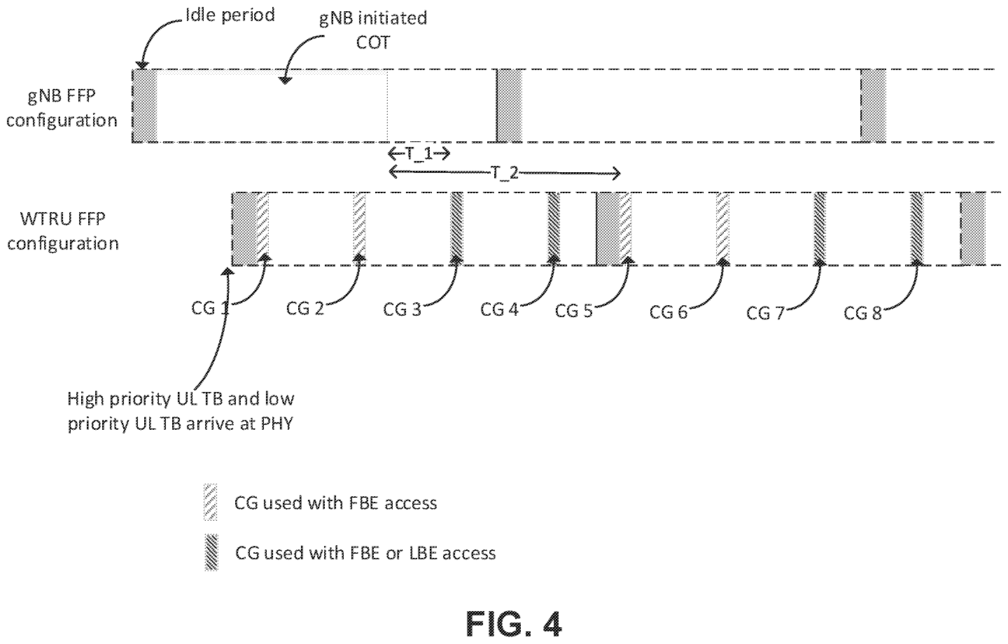

FIG. 4 illustrates an example of handling multiple transmissions (e.g., multiple transmissions colliding, arriving at the same time, available at the same time, etc.). FIG. 4 shows an example of a case where a WTRU has multiple data/TBs (e.g., two TBs) to transmit prior to a CG (e.g., CG1). As shown by example in FIG. 4, the WTRU may transmit one TB (e.g., only one of the two TBs) in the CG resource (e.g., CG1). The WTRU may, for example, select a transmission (e.g., the higher priority transmission) for transmission in CG1. As shown in FIG. 4, there is an ongoing gNB initiated COT. The COT structure may enable the WTRU to transmit in CG1, but not in CG2 (e.g., if CG2 is effectively voided by the gNB). The WTRU may transmit the higher priority TB in CG1. The WTRU may determine for the low priority TB whether CG3 is valid (e.g., the low priority TB was not transmitted in CG1 or CG2 and needs to be transmitted). For example, the WTRU may determine for the low priority TB whether CG3 is valid as a function of the time between the last DL transmission and CG3 (e.g., T_1). The WTRU may not transmit on CG3 using FBE channel access techniques if T_1 is greater than a threshold. The WTRU may determine to use LBE resource CG3 if T_1 is greater than a threshold. The time between the end of the gNB initiated COT and the next WTRU FFP start time (e.g., T_2) may be larger than a threshold and may incur a large amount of transmission latency. The WTRU may (e.g., if T_2 is larger than the threshold) use LBE resources, such as CG3, for example if T_2 is greater than its threshold and/or T_1 is greater than its threshold. The WTRU may determine to wait until the WTRU's next WTRU FFP start time if T_1 is less than its threshold and/or T_2 is less than its threshold.

An example scenario similar to the scenario shown in FIG. 4 may occur if the collision occurred at CG5 and the WTRU initiated an FBE COT for CG5, but there was no other transmission prior to CG6, which may render the COT inactive. For example, if there are no other transmission(s) between CG5 and CG6 and if the time between the end of the transmission in CG5 and the beginning of the resource for CG6 is greater than a threshold, the WTRU may consider the WTRU-initiated COT no longer active for transmission on CG6. The WTRU may not transmit in CG6 given that CG6 is configured as an FBE resource and may only be used when there is an ongoing and/or active COT. In such a case, the WTRU may use LBE resource CG7 or CG8 for the transmission of the lower priority TB.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-16. (canceled)

17. A wireless transmit receive unit (WTRU), comprising:
a processor configured to:
receive configuration information, wherein the configuration information comprises an indication of a first resource associated with a first operating condition, and wherein the first resource is in a first fixed frame period (FFP);
determine, during the first FFP, that data is available; and
transmit the data, wherein the data is transmitted in the first FFP using a second resource if conditions are satisfied, wherein the second resource is associated with a second operating condition, wherein the conditions comprise that the WTRU has initiated a second COT, and wherein the conditions further comprise one or more conditions from a set of conditions comprising:
a first amount of time after a first channel occupancy time (COT) associated with the first operating condition has ended exceeds a first threshold, or
a second amount of time between the second resource and a second FFP exceeds a second threshold.

18. The WTRU of claim 17, wherein the first operating condition is a condition during which available data is allowed to be sent in the first resource associated with the first operating condition in the first FFP if the first COT is ongoing or the first amount of time after the first COT associated with the first operating condition has ended is below the first threshold.

19. The WTRU of claim 18, wherein the first operating condition is associated with a frame-based equipment (FBE) configuration.

20. The WTRU of claim 17, wherein the second operating condition is a condition during which available data is allowed to be sent in the second resource associated with the second operating condition in the first FFP if the conditions are met.

21. The WTRU of claim 20, wherein the second operating condition is associated with a load-based equipment (LBE) configuration.

22. The WTRU of claim 17, wherein the set of conditions further comprises: an activation being received or a priority of the data being above a third threshold.

23. The WTRU of claim 17, wherein a value of the second threshold is based on a priority of the data.

24. The WTRU of claim 23, wherein as the priority of the data increases the value of the second threshold is decreased.

25. A method performed by a wireless transmit receive unit (WTRU), the method comprising:
receiving configuration information, wherein the configuration information comprises an indication of a first resource associated with a first operating condition, and wherein the first resource is in a first fixed frame period (FFP);
determining, during the first FFP, that data is available; and
transmitting the data, wherein the data is transmitted in the first FFP using a second resource if conditions are satisfied, wherein the second resource is associated with a second operating condition, wherein the conditions comprise that the WTRU has initiated a second COT, and wherein the conditions further comprise one or more conditions from a set of conditions comprising:
a first amount of time after a first channel occupancy time (COT) associated with the first operating condition has ended exceeds a first threshold, or
a second amount of time between the second resource and a second period exceeds a second threshold.

26. The method claim 25, wherein the first operating condition is a condition during which available data is allowed to be sent in the first resource associated with the first operating condition in the first FFP if the first COT is ongoing or the first amount of time after the first COT associated with the first operating condition has ended is below the first threshold.

27. The method of claim 26, wherein the first operating condition is associated with a frame-based equipment (FBE) configuration.

28. The method of claim 25, wherein the second operating condition is a condition during which available data is allowed to be sent in the second resource associated with the second operating condition in the first FFP if the conditions are met.

29. The method of claim 28, wherein the second operating condition is associated with a load-based equipment (LBE) configuration.

30. The method of claim 25, wherein the set of conditions further comprises: an activation being received or a priority of the data being above a third threshold.

31. The method of claim 25, wherein a value of the second threshold is based on a priority of the data.

32. The method of claim 31, wherein as the priority of the data increases the value of the second threshold is decreased.
